(19) United States
(12) Patent Application Publication
(10) Pub. No.: US 2026/0354603 A1
(43) Pub. Date: Nov. 12, 2026

(54) Shelf support system and wall paneling comprising such a shelf support system

(71) Applicant: L. & S. ITALIA S.P.A., Maron di Brugnera (IT)

(72) Inventors: Eris DA ROS, Maron di Brugnera (IT); Matteo MARINO, Maron di Brugnera (IT)

(21) Appl. No.: 19/355,505

(22) Filed: Oct. 10, 2025

(30) Foreign Application Priority Data
Oct. 10, 2024 (IT) 102024000022578

(51) Int. Cl. A47F 11/10; A47B 96/06; H01R 25/14

(52) U.S. Cl. CPC A47F 11/10; A47B 96/067; H01R 25/14; A47B 2220/0077

(57) ABSTRACT

Shelf support system (1) comprising a shelf (2) comprising: a main body (20), a lighting device, a first (21) and a second connection elements (22). Each connection element (21, 22) comprises a conductive element (23) that includes a coupling portion (25) and a power supply portion (26), and an insulating element (24) that includes a fulcrum portion (27). Said connection elements (21, 22) are connected to the main body (20) in such a way that the fulcrum portion (27) is interposed between the coupling portion (25) and the main body (20). Each power supply portion (26) is electrically connected to the power supply device. The shelf support system (1) comprises a support structure (3) comprising a central housing (30), in which a first (41) and a second central electrified rails (42) are housed, and comprising a central opening (31) through which the connection elements (21, 22) of the shelf (2) are inserted into the central housing (30), so that the coupling portion (25) of the first connection element (21) abuts the first central electrified rail (41) and the coupling portion (25) of the second connection element (22) abuts the second central electrified rail (42), and that the fulcrum portions (27) of the first (21) and the second connection elements (22) both abut a first wall (32) delimiting such central housing (30), each power supply portion (26) being electrifiable via said abutment between the coupling portions (25) and the central electrified rails (41, 42), to power the lighting device.

### TECHNICAL FIELD

The present invention relates to a shelf support system and a wall panelling comprising such a shelf support system.

Specifically, this support system comprises a shelf, which includes a lighting device, and a support structure, configured to support the shelf and power the lighting device.

### DEFINITIONS

In the following, the shelf support system may also be called “system” for simplicity.

In the context of the present invention, the expressions “supplying electrical energy”, “electrifying”, “energizing”, “passing current”, “powering”, etc. are used synonymously.

### STATE OF THE ART

In known solutions, spring elements or electrical contacts or tabs made of conductive material are used, which, when the shelf is connected to the support structure, interface with electrified rails in that structure, so as to electrify the shelf lighting device.

For example, patent application EP3659471A1 shows a support system in which spherical contacts placed on the shelf are used to connect to the electrified rails, allowing the lighting device on the shelf to be powered.

A problem with known solutions is the use of the aforementioned spring elements, electrical contacts or tabs made of conductive material, which cause instability and poor accuracy in the electrical connection between the shelf and the electrified rail, resulting in false contacts, flickering, flashing or switching off of the lighting device. This can occur, for example, due to movements of the shelf, which a user can detach and re-attach incorrectly to the support structure. In addition, components such as spring elements, electrical contacts and tabs tend to wear out over time, causing the aforementioned problems.

Patent application EP2292120A1 describes a traditional device for supporting objects, in particular for the presentation of goods, in which object holders are mounted on a support profile fixed to a wall.

The device uses low-voltage conductive rails arranged in the support profile to power electrical loads, such as lighting elements, on the object holder. It is provided with an adapter comprising electrically conductive contacts on the source side, which, when the object holder is inserted into the support profile, enter into electrical connection with the conductive rails in the profile itself.

In detail, one of the conductive rails is constructed as a metal strip bent into an S-shaped cross-section, which is fixed to the support profile only in the lower region, while the upper region of the metal strip is free and is therefore designed to be elastic. When the adapter is inserted, the conductive rail is pressed downwards and the elastic force acting upwards ensures a secure contact against the intended contact provided on the adapter.

This solution has technical limitations due to the functional dependence on the elastic element to ensure the contact force between the adapter contacts and the conductive rails. In particular, the use of elastically shaped conductive rails means that the contact force required to ensure the electrical connection is generated and maintained by the elastic mechanical properties of the rail itself, which can degrade over time. This configuration implies that the stability and reliability of the electrical connection over time depend on the constancy of the elastic characteristics of the conductive rail material. Furthermore, the elastic force exerted by the conductive rail is localised at the contact zone with the adapter contact, resulting in a concentration of mechanical stresses and contact pressure in limited areas. Dependence on elastic elements to generate the contact force also represents a constraint in the design of the system, as it requires the conductive rail to be made of suitable materials and geometries to ensure both the electrical conduction function and the function of an elastic element, to the detriment of design and construction simplicity.

In other words, this known solution allows shelves to be powered via central rails and coupled by rotation about a fulcrum; however, it lacks the stability of the electrical contact under operational stresses by relying on dedicated elastic elements.

It also leaves considerable scope for increasing safety in use by reducing the likelihood of accidental releases during unintended impacts or lifting. Installation and maintenance can be improved by limiting insertion forces and the risk of interface damage.

Further, this solution leaves room to optimise the bulks of the central housing while maintaining a reliable geometric coupling between coupling portions and rails while still meeting electrical compliance and user protection requirements.

### TECHNICAL PROBLEM

The problem underlying the present invention is to provide a shelf support system and wall panelling comprising the same, structurally and functionally designed to overcome, at least in part, one or more of the drawbacks complained of above with reference to the above-mentioned prior art.

In particular, it is an aim of the present invention to provide a shelf support system and related wall panelling to which electrical energy can be supplied in a particularly safe manner for a user.

A further aim of the present invention is to provide a shelf support system and related wall panelling in which shelf connection elements allow both the coupling of the shelf to the support structure and a stable electrical connection to power the shelf lighting device.

A further aim of the present invention is to provide a shelf support system and related wall panelling in which the arrangement of electrical cables is particularly orderly.

Another aim of the present invention is to provide a shelf support system and related wall panelling in which the shelf is easily removable and re-couplable to the support structure, ensuring the stability of the electrical connection with each new coupling of the shelf to the support structure.

The above-mentioned problem and aims are at least partly solved by the present invention by means of a shelf support system comprising one or more of the features expressed in the following claims and a wall panelling comprising such a shelf support system.

In particular, the inventor realised that in known solutions, including the one described in EP2292120A1, functional dependence on elastic elements to generate and maintain the contact force between the connection elements and the electrified rails can lead to reliability issues over time. Elastic components such as springs, tabs or elastically conformed conductive rails are in fact subject to mechanical fatigue phenomena, which can lead to progressive degradation of their elastic properties with a consequent reduction in contact force. This reduction can be particularly critical in systems subject to repeated shelf assembly and disassembly cycles, where cyclic stress accelerates the degradation of the elastic component. It is therefore a specific aim of the present invention to provide a shelf support system in which the electrical connection between connection elements and electrified rails is ensured by a mechanism that does not require any elastic elements interposed between the coupling portion and the electrified rail, thus eliminating dependence on components subject to elastic degradation over time.

The inventor also realised that the localised concentration of mechanical stresses and contact pressure in limited areas, typical of systems based on point elastic elements, can lead to localised wear phenomena on both the connection elements and the electrified rails. Such localised wear leads over time to an increase in the electrical contact resistance, with consequent negative effects such as voltage drops, possible localised overheating at the deteriorated contact zone, or even partial or total power failures of the lighting device. It is therefore a further specific aim of the present invention to provide a shelf support system in which the geometric conformation of the coupling portion is such that contact pressure is distributed over an adequate surface, reducing concentrations of mechanical stress and preventing localised wear phenomena that would compromise the reliability of the electrical connection over time.

The inventor also recognised that in systems where the shelf has to be frequently removed and re-coupled to the support structure, the repeated insertion and removal of the connection elements in the central housing can generate impulsive mechanical stresses that, in the absence of an appropriate geometric guide, risk causing plastic deformations, localised damage or component failures. Such mechanical damage, in addition to impairing the coupling functionality, can adversely affect the quality of the electrical contact. It is therefore a further specific aim of the present invention to provide a shelf support system in which the geometric conformation of the connection elements and the central housing is such as to guide the insertion according to an optimal trajectory, gradually distributing the mechanical stresses during the coupling and releasing steps and thus ensuring mechanical and electrical durability even with repeated operations.

The inventor also realised that in solutions in which the electrified rail must simultaneously perform the function of electrical conduction and the function of an elastic element to generate the contact force, there is a design constraint that seems to require the selection of materials and geometries capable of ensuring both functions, with possible trade-offs between electrical and mechanical performance. For example, a material that is optimal in terms of electrical conductivity may not possess the desired elastic features, or vice versa.

In addition, the geometric conformation required to achieve the required elastic properties can result in greater construction complexity and higher production costs. It is therefore a further aim of the present invention to provide a shelf support system that simplifies design and implementation by allowing the electrified rails to essentially perform only the function of electrical conduction, while the force required to maintain electrical contact is generated by an alternative mechanism based on the geometric conformation of the connection elements in combination with the weight of the shelf.

In other words, the inventor realised that the stability of the contact and the security of the coupling could be enhanced not by introducing springs or auxiliary contacts, but by shaping the end of the coupling portion so that it is spaced away with respect to the insulation and curved towards the rail, with a geometry that cooperates with the rotation induced by the weight of the shelf. From this perspective, the curved tip, preferably defined by an intermediate portion and an end that is substantially orthogonal thereto, allows for more robust self-positioning and a counteracting action to the release. In preferred variants, the contact surface can also cooperate with the plastic support of the rail, increasing mechanical stability, while a lower connection of the coupling portion can engage a complementary housing connection to guide insertion and release under reduced loads. Configurations with differentiated lengths of the coupling portions and offset rail positioning make it possible to optimise the bulks while preserving the reliability of the interface. These features, individually or in minimum combination, contribute to achieving the desired technical effects. From this insight, the inventor then expanded the technical concept underlying the invention by developing the invention as defined in the appended independent claim and in the related dependent claims.

### SUMMARY OF THE INVENTION

In a first aspect thereof, the present invention relates to a shelf support system comprising a shelf and a support structure. The shelf comprises a main body, a lighting device, a first and a second connection elements. Each connection element comprises a conductive element that includes a coupling portion and a power supply portion, and an insulating element that includes a fulcrum portion. Preferably, the connection elements are connected to the main body in such a way that the fulcrum portion is interposed between the coupling portion and the main body. The support structure comprises a central housing in which a first and a second central electrified rails are housed. This central housing comprises a central opening through which the connection elements of the shelf are inserted into the central housing, so that the coupling portion of the first connection element abuts the first central electrified rail and the coupling portion of the second connection element abuts the second central electrified rail, and so that the fulcrum portions of the first and second connection elements both abut a first wall delimiting this central housing. The weight of the shelf generates a rotation about the fulcrum portion that keeps the coupling portion of the first and second connection elements in contact with the first and second central electrified rails, respectively. Each power supply portion can be electrified through the abutment between the coupling portions and the central electrified rails, to power the lighting device.

In accordance with the at least one aspect of the present solution, the at least one coupling portion and/or the respective central electrified rail to which the at least one coupling portion is configured to electrically interface with an electrically conductive contact zone, may have a conformation selected from among several alternatives configured to ensure electrical contact by exploiting the weight of the shelf without the need for interposed elastic elements or by exploiting a force exerted by means of a locking device operable by the installer.

In accordance with at least one aspect of the present solution, said conformation may comprise an articulated conformation comprising at least one intermediate portion and a contact element adapted to establish electrical contact with a central electrified rail. This articulated conformation can allow for optimisation of the lever arm and the distribution of electrical contact forces.

In accordance with at least one of the aspects of the present solution, said conformation may comprise a movable contact element with respect to a base portion of the coupling portion or the central electrified rail.

The mobility of the contact element can allow automatic adjustment by compensating for dimensional tolerances.

In accordance with at least one of the aspects of the present solution, said conformation may comprise at least one of a receiving cavity and a protrusion, configured for electrical coupling with a complementary conformation present on the central electrified rail or, respectively, on the coupling portion and/or an element associated thereto. Such geometric coupling can perform both the mechanical and electrical functions simultaneously.

In accordance with at least one aspect of the present solution, said conformation may comprise at least one elastically deformable section. The presence of localised elasticity in the coupling portion can allow mechanical and electrical properties to be optimised separately.

In accordance with at least one aspect of the present solution, said conformation may comprise an inclined profile or wedge conformation configured to generate a shape coupling adapted to determine a contact force by controlled geometric interference. Such a profile can effectively convert the weight of the shelf into normal contact force.

In this description, the term “abuts” in relation to the interaction between the electrified rails and the coupling portion of the related connection element, as well as more generally between components adapted for mutual transmission of electrical current, is to be understood in the same way as “electrically connects”, i.e. the abutment is not necessarily to be understood as direct physical contact, but equally as indirect contact or any interaction suitable for the transmission of electrical energy, including by means of an induction effect, which does not involve an abutment in the sense of physical contact in the strict sense.

Thanks to the above-mentioned features, once the shelf is coupled to the support structure, the electrical contact between the coupling portions and the central electrified rails is also ensured by lever effect. The main body of the shelf protruding outwards from the housing is in fact subject to the force of gravity, and the rotation caused by this force tends to push the coupling portion, keeping it firmly in contact with the respective central electrified rail.

This renders superfluous the spring elements, electrical contacts and tabs made of conductive material present in shelves of the prior art, since in the shelf of the invention it is precisely the connection element of the shelf, in particular its coupling portion, that directly abuts the central electrified rail, ensuring the power supply of the lighting device.

The fulcrum portion is at the interface between the insulating element and the support structure, which makes it possible to avoid electrifying the support structure itself. In this way, it is possible to stay within the limits imposed by regulations, limiting any possible spread of electrical energy onto portions of the system that may come into contact with a user.

In a second aspect thereof, the present invention relates to a wall panelling comprising a shelf support system according to the invention, a lower structure, an upper structure, a lower cladding panel and an upper cladding panel, said lower cladding panel being held in place by means of the lower structure and the support structure and said upper cladding panel being held in place by means of the upper structure and the support structure.

Thanks to the above-mentioned features, it is possible to obtain a wall panelling in which the delivery of electrical energy is particularly safe for a user and in which the shelf is easily removable and re-couplable to the support structure, ensuring the stability of the electrical connection each time the shelf is re-coupled to the support structure.

In at least one of the above-mentioned aspects, the present invention can present at least one or several of the features described below.

In accordance with at least one aspect of this solution, at least one coupling portion can be configured with an electrically conductive contact zone adapted to interface with the respective central electrified rail.

This configuration can allow the electrical connection to be made without the need for additional interface elements interposed between the coupling portion and the rail, simplifying the overall system structure and reducing the number of components subject to wear or degradation over time.

In accordance with at least one aspect of the present solution, said at least one coupling portion may have a geometric conformation configured in such a way that the weight of the shelf, through rotation about the fulcrum portion, generates and maintains by gravity a contact force between said contact zone and the respective central electrified rail even in the absence of elastic elements interposed between the coupling portion and the central electrified rail. In this way, it is possible to utilise the shelf's own weight as the mechanism for generating the contact force, eliminating dependence on elastic components such as springs or tabs that are subject to degradation of mechanical properties through fatigue, thus ensuring stability of the contact force and reliability of the electrical connection throughout the system's service life.

In accordance with at least one aspect of the present solution, said geometric conformation of the coupling portion may comprise an articulated conformation comprising at least an intermediate portion and a contact element. The presence of an intermediate portion interposed between the insulating element and the contact element can make it possible to provide a lever arm which, by exploiting the weight of the shelf applied at a distance from the fulcrum, multiplies the normal force exerted by the contact element on the central electrified rail, ensuring a high and stable contact pressure even with shelves of low weight, and at the same time distributing this pressure over a greater contact surface with respect to configurations without articulation, reducing localised wear.

In accordance with at least one aspect of the present solution, the present geometric conformation of the coupling portion may comprise a conformation comprising a movable contact element with respect to a base portion of the coupling portion. The mobility of the contact element with respect to the base portion can allow automatic adjustment of the contact element's position with respect to the central electrified rail, compensating for any manufacturing or assembly tolerances and ensuring reliable electrical contact even in the presence of geometric variability, while also reducing mechanical stresses during the insertion and removal of the shelf thanks to the mobile element's ability to follow optimal trajectories. In accordance with at least one aspect of the present solution, this geometric conformation of the coupling portion may comprise at least one of a receiving cavity and a protrusion, configured by geometric coupling with a complementary conformation present on the central electrified rail or an element associated thereto. Geometric coupling between complementary conformations can allow the mechanical connection function and the electrical connection function to be implemented simultaneously through a single geometrical constraint, simplifying the overall structure and production simplicity, ensuring that the correct mechanical positioning automatically coincides with the correct electrical positioning, reducing the risk of incorrect assembly and facilitating coupling operations by the user.

In accordance with at least one aspect of the present solution, said geometric conformation of the coupling portion may comprise at least one elastically deformable section. The presence of an elastically deformable section in the coupling portion itself, rather than in the central electrified rail, can allow the elastic function to be concentrated in a component that can be replaced in the event of degradation, leaving the central electrified rail as a purely conductive element and thus not subject to mechanical elastic requirements, simplifying the design and construction of the rail itself and allowing the independent optimisation of the electrical and mechanical properties of the respective components.

In accordance with at least one aspect of the present solution, said geometric conformation of the coupling portion may comprise an inclined profile or wedge conformation configured to generate contact force by controlled geometric interference. An inclined or wedge profile can convert the force component resulting from the weight of the shelf in the insertion direction into a normal force component perpendicular to the contact surface with the central electrified rail, by means of a controlled geometric interference mechanism that does not require any elastic elements, ensuring a contact force proportional to the weight of the shelf and therefore constant over time, independently of elastic degradation phenomena.

In accordance with at least one aspect of the present solution, each coupling portion may comprise a contact end that interfaces with the respective central electrified rail, such contact end being distal with respect to the insulating element and curved towards the respective central electrified rail. The curvature of the contact end towards the central electrified rail can allow for an increase in the effective contact surface with respect to a straight end, distributing the contact pressure over a larger area and reducing concentrations of mechanical stress that would cause localised wear, while also ensuring that the normal to the contact surface is oriented favourably with respect to the direction of the applied force, maximising the force component useful in maintaining electrical contact.

In accordance with at least one aspect of the present solution, the coupling portion may comprise an intermediate portion interposed between the contact end and the base portion, and thus between the contact end and the insulating element. The presence of an intermediate portion can make it possible to create a lever arm of defined length between the fulcrum, positioned at the fulcrum portion of the insulating element, and the distal contact end, allowing the relationship between the weight of the shelf and the contact force generated on the central electrified rail to be modulated through the choice of the length of the intermediate portion, and also allowing the contact end to be oriented at an optimal angle with respect to the rail regardless of the orientation of the base portion with respect to the insulating element.

In accordance with at least one aspect of the present solution, the contact end may be curved with respect to the intermediate portion so as to be substantially perpendicular to that intermediate portion. A substantially perpendicular curvature between the contact end and the intermediate portion can allow for a substantially “L” or “J” shaped section geometry which, by exploiting the lever principle, effectively transforms the weight of the shelf into a contact force directed perpendicularly to the surface of the central electrified rail, maximising the effectiveness of the electrical contact while ensuring a mechanical coupling function that prevents the accidental release of the shelf due to the geometric interface between the curved contact end and the rail.

In accordance with at least one aspect of the present solution, the coupling portion may include a lower connection between the contact end and the intermediate portion, and the first wall of the central housing may comprise a connection at the lower connection of the coupling portion when the shelf is coupled to the support structure. The presence of coordinated connections between the coupling portion and the central housing can allow the trajectory of the coupling portion to be guided during insertion into and removal from the housing, gradually distributing mechanical stresses rather than concentrating them in abrupt geometric transitions, thus reducing the risk of plastic deformation, localised damage or component breakage even with repeated assembly and disassembly operations of the shelf, and also facilitating insertion thanks to an automatic centring effect that directs the coupling portion to the correct position. “Conductive element” means an electrically conductive element.

Preferably, the conductive element is made of a metal material, even more preferably zamak or aluminium.

“Insulating element” means an electrically insulating element.

In some embodiments, the first and second central electrified rails are powered via a mains connection, preferably via an electrical cable and a power supply unit connected to the mains. Preferably, the first central electrified rail is configured to conduct the positive pole of the power supply and the second central electrified rail is configured to conduct the negative pole of the power supply, or vice versa.

Preferably, each central electrified rail comprises a plastic element, e.g. made of polycarbonate, and a conductive tab, e.g. made of copper.

Preferably, the electrified rails extend along a longitudinal direction of the support structure. Preferably, the central housing extends along that longitudinal direction.

Preferably, when the support system is in use, e.g. wall-mounted, the longitudinal direction substantially corresponds to a horizontal direction, perpendicular to the direction of the force of gravity.

Preferably, the first wall of the central housing is a lower wall of that housing. “Lower wall” means that the first wall delimits the central housing at the bottom, when the support system is in use, e.g. wall-mounted.

Preferably, the shelf comprises a first and second electrical cables connecting the lighting device with the power supply portion of the first and second connection elements, respectively. Each power supply portion can be electrified through the abutment between the coupling portions and the central electrified rails, so that the lighting device is preferably powered via said first and second power cables.

Preferably, the first electrical cable is soldered to the lighting device and the power supply portion of the first connection element and the second electrical cable is soldered to the lighting device and the power supply portion of the second connection element.

Preferably, the lighting device is configured as an LED lighting device. Preferably, the lighting device comprises an LED strip.

Preferably, the shelf is removably connectable to the support structure.

Preferably, the support structure is shaped like an extrudate, i.e. it is obtained by extrusion moulding. Preferably, the support structure is made of aluminium.

Preferably, when the shelf is coupled to the support structure, both fulcrum portions abut the first wall of the housing along the same interface line. Preferably, this interface line is substantially straight and parallel to the longitudinal direction of the support structure.

Preferably, the main body of the shelf comprises a support surface. Objects, for example, can be placed on this surface.

In some embodiments, the shelf may comprise additional connection elements, preferably non-electrifiable. These additional connection elements preferably include a coupling portion to connect to the central housing of the support structure. In this way, the load capacity of the shelf can be increased.

In some embodiments, it is possible to connect a plurality of shelves to the same support structure. Preferably, these shelves are aligned along the longitudinal direction.

In alternative embodiments, the shelf may comprise a single connection element. Preferably, such a single connection element includes an insulating portion, a first and second coupling portions and a first and second power supply portions, said insulating portion being interposed between said first and second coupling portions and between said first and second power supply portions.

In accordance with a preferred embodiment, the insulating element is configured as a casing comprising a cavity in which the conductive element is inserted, so that the coupling portion and the power supply portion protrude from such cavity of the insulating element.

This makes it possible to partially wrap the conductive element with the insulating element in a particularly effective manner. Furthermore, in the event of maintenance, only the conductive element or only the insulating element can be replaced after separating them.

Preferably, the insulating element is made of polymer material, even more preferably polycarbonate.

Preferably, each conductive element comprises a base portion from which the coupling portion and the power supply portion project. Preferably, the base portion is inserted into the cavity of the insulating element, so that the coupling portion and the power supply portion are left uncovered.

Preferably, the insulating element comprises a front opening from which the coupling portion of the conductive element exits the cavity of the insulating element and a side opening from which the power supply portion of the conductive element exits the cavity of the insulating element.

Preferably, the conductive element and the insulating element are obtained by moulding.

In a preferred embodiment, the conductive element and the insulating element are obtained by overmoulding. This allows the connection element to be obtained with the conductive element already automatically inserted into the insulating element, downstream of the overmoulding process.

In alternative embodiments, the conductive element and the insulating element are obtained through separate moulds. In this case, the conductive element must be manually inserted into the insulating element, downstream of the moulding process, to obtain the connection element.

In alternative embodiments, the insulating element is obtained by applying an electrically insulating coating to the conductive element, with the exception of a first area at the coupling portion and a second area at the power supply portion. Preferably, the electrically insulating coating comprises a paint layer, even more preferably an epoxy powder paint. This embodiment, with respect to the embodiment involving the moulding of the conductive element and the insulating element, has the disadvantage that the paint can be inadvertently removed, particularly due to the handling of the shelf.

According to a preferred embodiment, each coupling portion comprises a contact end that interfaces with the respective central electrified rail, such contact end being distal with respect to the insulating element and being curved towards the respective central electrified rail. Thanks to the aforementioned conformation of the coupling portion, it is possible to achieve both a stable contact with the central electrified rail and a particularly effective coupling of the shelf to the support structure. This conformation also prevents accidental release of the shelf from the support structure, since to release the shelf the main body must first be rotated, e.g. by about 10-15° upwards, so that the contact end is disconnected from the respective central electrified rail, and then the shelf can be pulled out of the central housing. Preferably, the coupling portion comprises an intermediate portion, interposed between the contact end and the base portion, and then between the contact end and the insulating element.

Preferably, the contact end is curved with respect to the intermediate portion, so that it is substantially perpendicular to that intermediate portion.

Preferably, the contact end is curved so that the coupling portion has a substantially L-shaped cross-section.

Preferably, the coupling portion includes a lower connection between the contact end and the intermediate portion. Preferably, the first wall of the central housing comprises a connection at the lower connection of the coupling portion, when the shelf is coupled to the support structure. This makes it even easier to couple and release the connection elements in the central housing, reducing the risk of damage.

In accordance with a preferred embodiment, the central housing comprises a first groove into which the first central electrified rail is inserted and a second groove into which the second central electrified rail is inserted.

By separating the central electrified rails in their respective grooves, it is possible to optimise the bulks in the central housing particularly effectively.

According to a preferred embodiment, the grooves are formed at a second wall of the central housing, this second wall being placed higher with respect to the first wall.

“Higher” means that the second wall is positioned higher along the direction of the force of gravity with respect to the first wall when the support structure is in use, e.g. when wall-mounted.

In this way, it is possible to position the central electrified rails at the grooves at the top of the housing, and consequently to safeguard these rails from possible water infiltrations, which would instead accumulate at the first wall of the central housing, and thus where there are no such rails.

Preferably, the second wall of the central housing is an upper wall of that housing. “Upper wall” means that the second wall delimits the central housing superiorly, when the support system is in use, e.g. wall-mounted.

Preferably, the first wall of the central housing opposes the first wall.

Preferably, when the shelf is coupled to the support structure, the contact ends face upwards, i.e. towards the second wall. This allows these ends to permanently interface with the central electrified rails located in the grooves.

Preferably, the grooves can be configured so that the first central electrified rail is further away from the second central electrified rail with respect to the first wall of the central housing, or vice versa.

This allows further optimised utilisation of the available space in the central housing.

In accordance with a preferred embodiment, the first groove is further away from the central opening with respect to the second groove, and the coupling portion of the first connection element has a greater length than a length of the coupling portion of the second connection element.

By offsetting the positioning of the grooves, it is also possible to offset the positioning of the respective central electrified rails in the central housing, so that the rail furthest away from the central opening can be reached from the longer coupling portion and the rail less distant from the central opening can be reached from the shorter coupling portion, further optimising the space available in the central housing.

Preferably, the intermediate portion of the coupling portion of the first connection element has a greater length than the length of the intermediate portion of the coupling portion of the second connection element.

According to a preferred embodiment, the power supply portion projects laterally with respect to the insulating element so that both insulating elements are interposed between said power supply portions.

This provides better electrical insulation to prevent short circuits, reduce electromagnetic interference, even out current distribution and improve thermal management.

Preferably, each power supply portion is shaped like an eyelet.

This improves the mechanical stability of the connection with the first and second electrical cables, reducing the risk of accidental disconnections and ensuring reliable electrical transmission over time.

In accordance with a preferred embodiment, the main body of the shelf includes a first housing and a second housing. Preferably, the power supply portion and the insulating element, with the exception of the fulcrum portion, of each connection element is housed in the first housing. Preferably, the second housing accommodates the lighting device. Preferably, the first housing comprises a first and second side openings, these side openings being mutually opposed. Preferably, the power supply portion of the first connection element is at the first side opening and the power supply portion of the second connection element is at the second side opening. Preferably, the first electrical cable passes through the first opening to reach the second housing, connecting the power supply portion of the first connection element with the lighting device, and the second electrical cable passes through the second opening to reach the second housing, connecting the power supply portion of the second connection element with the lighting device.

This makes it possible to achieve a particularly orderly arrangement of the cables, separating them and avoiding the risk of tangling.

Preferably, the power supply portion does not come into contact with walls that limit the first housing. This avoids electrification of the main body of the shelf.

Preferably, the shelf comprises a retaining system that includes first retaining elements placed inside the first housing and second retaining elements placed on the insulating element of each connection element. Preferably, the first retaining elements are shaped like projections and the second retaining elements are shaped like recesses, or vice versa.

Thanks to the retaining system, it is possible to optimise the connection between connection elements and the main body of the shelf, preventing accidental release.

Preferably, the second housing comprises mutually opposed side openings.

Preferably, the main body of the shelf comprises a third housing interposed between the first and second housings and configured to accommodate the first and second cables.

This makes it possible to further optimise the arrangement of cables providing a dedicated housing for their positioning. This also allows the cables to be arranged in an orderly manner, limiting wear.

Preferably, the third housing comprises mutually opposed side openings.

According to a preferred embodiment, the shelf comprises a first side cover element, mounted on the main body of the shelf to cover the first opening, and a second side cover element, mounted on the main body of the shelf to cover the second opening.

These cover elements are connected in a removable manner, so that maintenance work, e.g. on cables, can be carried out particularly easily.

Preferably, the side cover elements cover the side openings of the second housing and, if provided, the third housing.

In some embodiments, the connection elements inserted into the first housing are coupled to the main body of the shelf by interference.

In accordance with a preferred embodiment, the first housing is delimited by a transverse wall and each insulating element comprises a fastening element that can be fastened to said transverse wall.

This makes it possible to size the connection elements to fit easily into the first housing and keep them fastened in a specific position by means of the fastening elements.

Preferably, the fastening element is fastened to the transverse wall by means of a threaded connection. Preferably, the fastening element is configured as an eyelet. This makes it possible to achieve a particularly stable connection, and, if necessary, to disconnect the fastening element from the wall, e.g. in the event of maintenance operations or replacement of connection elements.

According to a preferred embodiment, the support system comprises a side structure into which a side electrified rail is inserted. Preferably, the support system comprises a first pin electrically connected to the first central electrified rail and a second pin electrically connected to the second central electrified rail. Preferably, the side structure is positioned with respect to the support structure so that the first and second pins abut the side electrified rail.

This configuration makes it possible to supply power to a plurality of first and second central electrified rails using a single source, obviating the need to provide independent power supplies for each pair of central electrified central rails, simplifying cable management.

Preferably, the pins are placed along the longitudinal direction of the support structure, i.e. parallel to the central electrified rails.

Preferably, each pin is connected to the respective central electrified rail via a respective electrical cable. Preferably, each of these electrical cables is soldered to the pin and to the central electrified rail.

Preferably, the side electrified rail is powered via mains, even more preferably via an electrical cable and a power supply unit connected to the mains.

Preferably, the side electrified rail comprises a plastic element, e.g. made of polycarbonate, on which a first and a second conductive tabs, e.g. made of copper, are placed.

Preferably, the side structure extends along a height direction. This height direction substantially corresponds to the direction of the force of gravity. Preferably, the height direction of the side structure is substantially perpendicular to the longitudinal direction of the support structure. In this way, it is advantageously possible to arrange the side electrified rail perpendicular to the central electrified rails, and thus perpendicular to the pins.

Preferably, the side structure is conformed as an extrudate. Preferably, the side structure is made of aluminium.

In some embodiments, the support system comprises a plurality of support structures to which a respective shelf can be connected. Preferably, such support structures are arranged along the height direction. The side structure is particularly useful for powering the central electrified rails in these support structures, simplifying the power supply of the support system and avoiding the need to power each support structure individually.

Preferably, the support system comprises two side structures and the support structure is interposed between said two side structures. Preferably, the side structures abut the support structure laterally.

It is advantageous to have two side structures in that it is possible to place the side electrified rail in one or the other side structure, depending on the installation requirement, e.g. proximity to a mains socket, so that the side electrified rail can be easily connected to that socket.

In accordance with a preferred embodiment, the support system comprises a side connection device shaped to connect the support structure and the side structure.

This makes it possible to connect the side structure and the support structure effectively, keeping the side structure in the desired position with respect to the support structure.

Preferably, the side connection device comprises a first connection portion configured to connect with the support structure and a second connection portion configured to connect to the side structure.

In the event that the side structure that interfaces with the side connection device comprises the side electrified rail, this side connection device can advantageously also have the function of containing the pins and positioning them at this side electrified rail.

Preferably, the first and second pins are positioned in the side connection device, this device being conformed to align these pins with the side electrified rail.

This allows to keep the pins in place to ensure the connection to the side electrified rail, avoiding false contacts.

Preferably, the side connection device is configured to align each pin along a direction parallel to the longitudinal direction of the support structure.

According to a preferred embodiment, the side connection device comprises a first and a second elastic elements, the first elastic element exerting a thrust on the first pin and the second elastic element exerting a thrust on the second pin, to keep these pins in contact with the side electrified rail.

This makes it possible to keep the pins in contact with the side electrified rail in a particularly effective and stable manner, thanks to the thrust exerted by the aforementioned elastic elements on the respective pins.

Preferably, each elastic element is configured as a helical spring.

Preferably, each elastic element abuts a wall of the side connection device, on one side, and a pin shoulder, on the other side.

Preferably, the lower structure of the wall panelling comprises a support element configured to hold the lower cladding panel in place.

Preferably, the upper structure of the wall panelling comprises a support element configured to hold the upper cladding panel in place.

Preferably, the lower structure and the upper structure are conformed as an extrudate.

Preferably, the lower structure and the upper structure are made of aluminium.

Preferably, the cladding panels are made of wood or polymer material.

### BRIEF DESCRIPTION OF DRAWINGS

The features and advantages of the invention will become clearer from the detailed description of an embodiment shown, by way of indicative and non-limiting example, with reference to the appended drawings wherein:

FIG. 1 shows a perspective view of an embodiment of the wall panelling according to the invention;

FIG. 2 shows an exploded view of the wall panelling;

FIG. 3 shows an exploded view of the shelf;

FIG. 4 shows a cross-section of the support structure;

FIG. 5 shows a perspective view of the conductive element of the first connection element;

FIG. 6 is a cross-section of the side structure, at the interface between the pins and the side electrified rail;

FIG. 7 is a perspective view of the side connection device.

In the examples in the figures, a shelf support system is collectively referred to as 1 and a wall panelling as 100, made in accordance with the present invention.

The shelf support system 1 comprises a shelf 2 and a support structure 3.

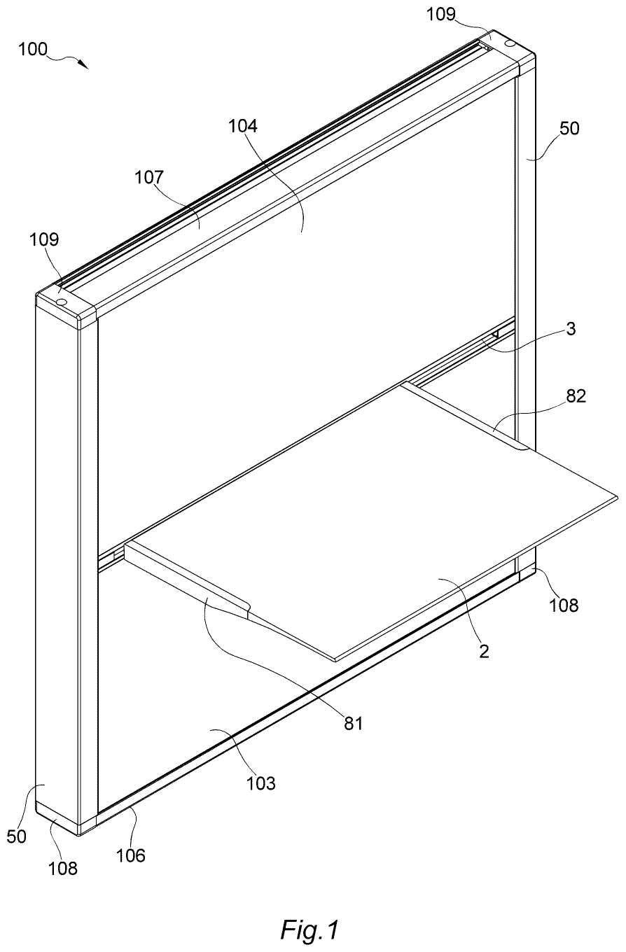

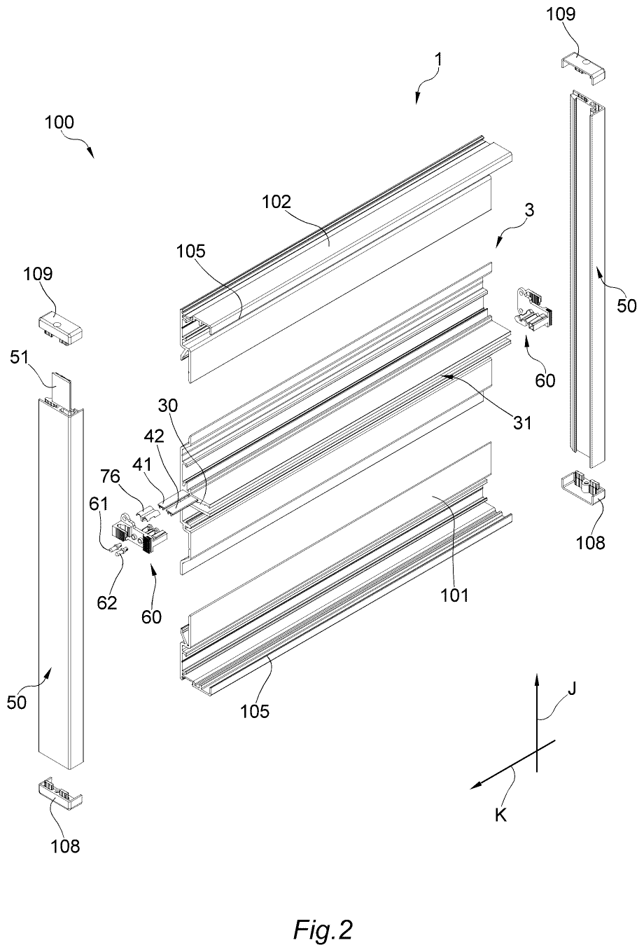

In the examples in FIGS. 1 and 2, an embodiment of the wall panelling 100 is shown, comprising the support system 1, a lower structure 101, an upper structure 102, a lower cladding panel 103 and an upper cladding panel 104. The lower cladding panel 103 is held in place by the lower structure 101 and the support structure 3, and the upper cladding panel 102 is held in place by the upper structure 102 and the support structure 3.

Preferably, the cladding panels 103, 104 are made of wood or polymer material.

Preferably, the wall panelling 100 comprises a lower cladding profile 106 covering the lower structure 101 and an upper cladding profile 107 covering the upper structure 102. Preferably, such cladding profiles 106, 107 are made of aluminium.

In the embodiment in FIG. 2, an exploded view of the wall panelling 100 is shown, in which the cladding panels 103, 104 and the cladding profiles 106, 107 are not depicted.

Preferably, the lower structure 101 of the wall panelling 100 comprises a support element 105 configured to hold the lower cladding panel 103 in place. Preferably, the upper structure 102 of the wall panelling 100 comprises a support element 105 configured to hold the upper cladding panel 104 in place.

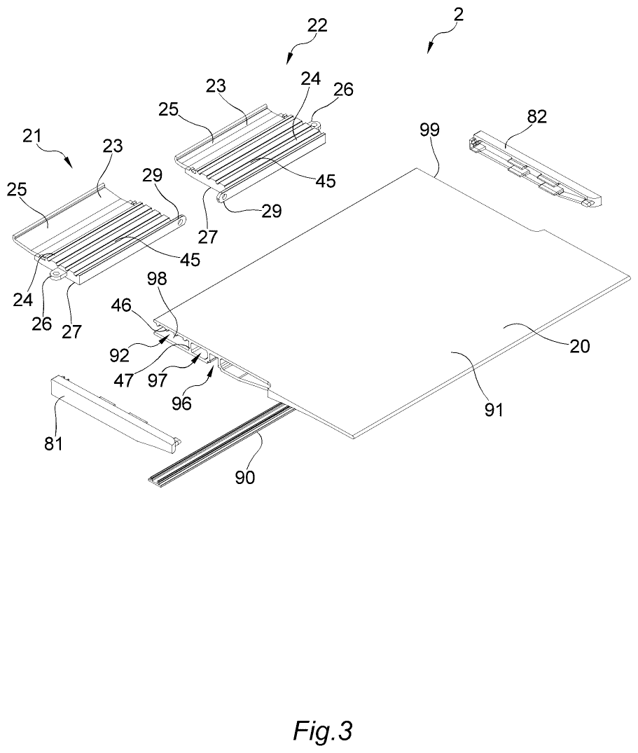

As can be seen in the example in FIG. 3, the shelf 2 comprises a main body 20, a lighting device (not shown), a first 21 and a second connection elements 22. Each connection element 21, 22 comprises a conductive element 23, which includes a coupling portion 25 and a power supply portion 26, and an insulating element 24, which includes a fulcrum portion 27. When the connection elements 21, 22 are connected to the main body 20, the fulcrum portion 27 is interposed between the coupling portion 25 and the main body 20.

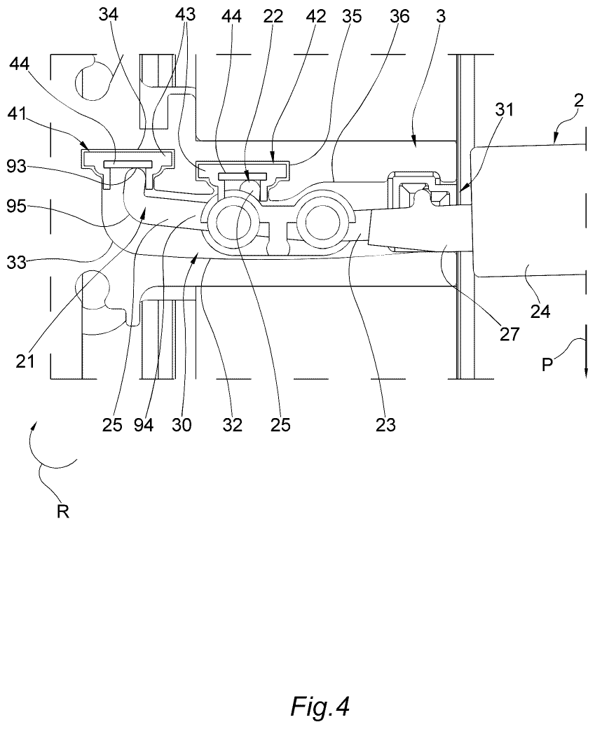

As can be seen in the examples in FIGS. 2 and 4, the support structure 3 comprises a central housing 30 in which a first 41 and a second central electrified rails 42 are housed. This central housing 30 comprises a central opening 31 through which the connection elements 21, 22 of the shelf 2 can be inserted into the central housing 30. The coupling portion 25 of the first connection element 21 abuts the first central electrified rail 41 and the coupling portion 25 of the second connection element 22 abuts the second central electrified rail 42. The fulcrum portions 27 of the first 21 and the second connection elements 22 both abut a first wall 32 delimiting the central housing 30.

The weight P of the shelf 2 generates a rotation R about the fulcrum portion 27 which keeps the coupling portion 25 of the first 21 and second connection elements 22 in contact with the first 41 and second central electrified rails 42, respectively. Each power supply portion 26 can be electrified by means of said abutment between the coupling portions 25 and the central electrified rails 41, 42, to power the lighting device.

Preferably, each central electrified rail 41, 42 comprises a plastic element 43, e.g. made of polycarbonate, and a conductive tab 44, e.g. made of copper. The function of the plastic element 43 is to prevent contact between the conductive tab 44 and the support structure 3. Preferably, the central electrified rails 41, 42 carry power at about 24V.

The central electrified rails 41, 42 extend along a longitudinal direction K of the support structure 3. The central housing 30 extends along this longitudinal direction K.

Preferably, the shelf 2 comprises a first and a second electrical cables (not shown) connecting the lighting device with the power supply portion 26 of the first 21 and second connection elements 22, respectively. Each power supply portion 26 can be electrified by means of said abutment between the coupling portions 25 and the central electrified rails 41, 42, so as to power the lighting device, preferably via said first and second electrical cables.

Preferably, the lighting device is configured as an LED lighting device and comprises an LED strip.

Preferably, when the shelf 2 is coupled to the support structure 3, both fulcrum portions 27 abut the first wall 32 of the housing 30 along the same interface line. Preferably, this interface line is substantially straight and parallel to the longitudinal direction K of the support structure 3.

Preferably, the main body 20 of the shelf 2 comprises a support surface 91. It is possible, for example, to place objects on this support surface 91.

The insulating element 24 is configured as a casing comprising a cavity in which the conductive element 23 is inserted, so that the coupling portion 25 and the power supply portion 26 protrude from such cavity of the insulating element 24.

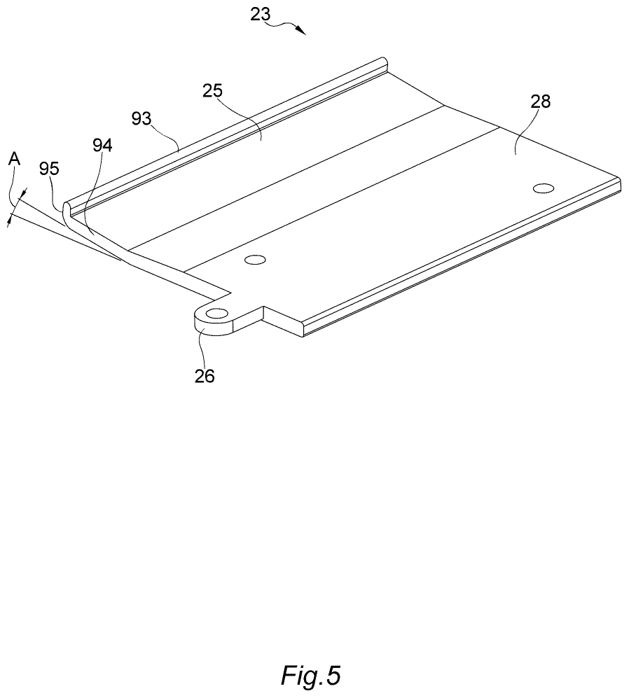

As can be seen in the example in FIG. 5, each conductive element 23 preferably comprises a base portion 28 from which the coupling portion 25 and the power supply portion 26 project. Preferably, the coupling portion 25 projects at the front of the base portion 28. Preferably, the coupling portion 25 is inclined with respect to the base portion 28 at an angle A comprised between about 5° and 10°, even more preferably about 7.5°. Preferably, the power supply portion 26 projects to the side of the base portion 28. Preferably, the power supply portion 26 is aligned with the base portion 80.

The conductive element 23 of the first connection element 21 differs from the conductive element 23 of the second connection element 22 in the length of the coupling portion 25, which is longer in the first connection element 21, and in the arrangement of the power supply portion 26, which, in the case of the second connection element 22, protrudes laterally from the base portion 28, but from the opposite side with respect to the first connection element 21, as can be seen in the example in FIG. 3.

Preferably, the base portion 28 is inserted into the cavity of the insulating element 24, so that the coupling portion 25 and the power supply portion 26 are left uncovered.

Each coupling portion 25 comprises a contact end 93 adapted to interface with the central electrified rail 41, 42, such contact end 93 being distal with respect to the insulating element 24 and being curved towards the respective central electrified rail 41, 42.

The contact end 93 directly contacts the conductive tab 44 of the central electrified rail 41, 42, to electrify the lighting device.

Preferably, the coupling portion 25 comprises an intermediate portion 94, interposed between the contact end 93 and the base portion 28, and then between the contact end 93 and the insulating element 24.

Preferably, the contact end 93 is curved with respect to the intermediate portion 94, so as to be substantially perpendicular to this intermediate portion 94. With this conformation, the coupling portion 25 has a substantially L-shaped cross-section.

Preferably, the coupling portion 25 includes a lower connection 95 between the contact end 93 and the intermediate portion 94. Preferably, the first wall 32 of the central housing 30 comprises a connection 33 at the lower connection 95 of the coupling portion 25, when the shelf 2 is coupled to the support structure 3.

The example in FIG. 4 shows a section along a plane transverse to the longitudinal direction K of the support structure 3, in which the contact end 93 of each connection element 21, 22 is shown to remain coupled with the respective central electrified rail 41, 42, due to the rotation R generated by the weight P of the shelf 2.

Preferably, the contact end 93 abuts both the conductive tab 44 and the plastic element 43. This ensures electrical contact and at the same time achieves a particularly stable coupling of the shelf 2 to the support structure 3.

The central housing 30 comprises a first groove 34 into which the first central electrified rail 41 is inserted and a second groove 35 into which the second central electrified rail 42 is inserted.

Preferably, each groove 34, 35 has a shape complementary to that of the central electrified rail 41, 42 housed within it.

Preferably, each central electrified rail 41, 42 is inserted into the respective groove 34, 35 along the longitudinal direction K of the support structure 3.

The grooves 34, 35 are obtained at a second wall 36 of the central housing 30. The second wall 36 is placed higher than the first wall 32 along the direction of the force of gravity when the support structure 3 is in use.

Preferably, the first wall 32 is a lower wall of the central housing 30 and the second wall 36 is an upper wall of the central housing 30. The second wall 36 can be opposed to the first wall 32.

When the shelf 2 is coupled to the support structure 3, the contact ends 93 face the second wall 36.

Preferably, the grooves 34, 35 can be configured so that the first central electrified rail 41 is further away than the second central electrified rail 42 with respect to the first wall 32 of the central housing 30.

The first groove 34 is further away from the central opening 31 with respect to the second groove 35, and the coupling portion 25 of the first connection element 21 has a greater length than a length of the coupling portion 25 of the second connection element 22.

Preferably, the intermediate portion 94 of the coupling portion 25 of the first connection element 21 has a greater length than the length of the intermediate portion 94 of the coupling portion 25 of the second connection element 22.

The power supply portion 26 projects laterally with respect to the insulating element 24, so that both insulating elements 24 are interposed between said power supply portions 26.

Each power supply portion 26 is shaped like an eyelet.

The main body 90 of the shelf 2 includes a first housing 92 and a second housing 96. Preferably, the first housing 92 houses the insulating element 24, with the exception of the fulcrum portion 27, and the base portion 28 and the power supply portion 26 of the conductive element 23, of each connection element 21, 22.

The second housing 96 houses the lighting device. Preferably, the first housing 92 comprises a first side opening 98 and a second side opening 99, these side openings 98, 99 being mutually opposed. Preferably, the power supply portion 26 of the first connection element 21 is at the first side opening 98 and the power supply portion 26 of the second connection element 22 is at the second side opening 99. Preferably, a first electrical cable passes through the first opening 98 to reach the second housing 96, connecting the power supply portion 26 of the first connection element 21 with the lighting device, and a second electrical cable passes through the second opening 99 to reach the second housing 96, connecting the power supply portion 26 of the second connection element 22 with the lighting device.

Preferably, the main body 20 of the shelf 2 comprises a third housing 97 interposed between the first 92 and the second housings 96 and configured to accommodate the first and second cables.

Preferably, the second housing 96 and the third housing 97 comprise mutually opposed side openings.

Preferably, the first cable is soldered to the power supply portion 26 of the first connection element 21 and is passed through the first side opening 98 of the first housing 92, and then passed into the third housing 97 by entering through a first side opening of the third housing 97 (which is located on the same side as the first side opening 98 of the first housing 92) and exiting from the second side opening of the third housing 97 (which is located on the same side as the second side opening 99 of the first housing 92), and finally being passed into the second housing 96 through the second side opening of the second housing 96 (located on the same side as the second side opening 99 of the first housing 92) to be soldered to the lighting device located in the second housing 96.

Preferably, the second cable is soldered to the power supply portion 26 of the second connection element 22 and is passed through the second side opening 99 of the first housing 92, and then passed into the third housing 97 by entering through a second side opening of the third housing 97 (which is located on the same side as the second side opening 99 of the first housing 92) and exiting through the first side opening of the third housing 97 (which is located on the same side as the first side opening 98 of the first housing 92), and finally being passed into the second housing 96 through the first side opening of the second housing 96 (which is on the same side as the first side opening 98 of the first housing 92) to be soldered to the lighting device located in the second housing 96.

The shelf 2 comprises a retaining system comprising first retaining elements 46 placed inside the first housing 92 and second retaining elements 45 placed on the insulating element 24 of each connection element 21, 22. The first retaining elements 46 are shaped like projections and the second retaining elements 45 are shaped like recesses.

The main body 20 of shelf 2 comprises a diffuser screen 90, placed at a lower opening of the second housing 96. This allows to diffuse and soften the light produced by the lighting device, reducing glare and creating more even and pleasant lighting.

The shelf 2 comprises a first side cover element 81, connected to the main body 20 of the shelf 2 to cover the first side opening 98, and a second side cover element 82, connected to the main body 20 of the shelf 2 to cover the second side opening 99.

Preferably, the first side cover element 81 covers the first side opening of the second housing 96 and, possibly, the first side opening of the third housing 97.

Preferably, the second side cover element 82 covers the second side opening of the second housing 96 and, possibly, the second side opening of the third housing 97.

Preferably, the connection elements 21, 22 inserted into the first housing 92 are coupled to the main body 20 of the shelf 2 by interference.

The first housing 92 is delimited by a transverse wall 47 and each insulating element comprises a fastening element 29 that can be fastened to said transverse wall 47.

The fastening element is configured as an eyelet. The fastening element 29 can be fastened to the transverse wall 47 via a threaded connection.

The support system 1 comprises a side structure 50 into which a side electrified rail 51 is inserted. The support system 1 comprises a first pin 61 electrically connected to the first central electrified rail 41 and a second pin 62 electrically connected to the second central electrified rail 42. The side structure 50 is positioned with respect to the support structure 3 so that the first 61 and second pins 62 abut the side electrified rail 51.

The side electrified rail 51 can be powered via mains, e.g. by means of an electrical cable and a power supply unit (not shown) connected to the mains.

The pins 61, 62 are placed along the longitudinal direction K of the support structure 3, i.e. parallel to the central electrified rails 41, 42.

The side structure 50 extends along a height direction J, which substantially corresponds to the direction of the force of gravity. The height direction J of the side structure 50 is substantially perpendicular to the longitudinal direction K of the support structure 3. The side electrified rail 51 is substantially perpendicular to the central electrified rails 41, 42, and thus to the pins 61, 62.

Each pin 61, 62 is connected to the respective central electrified rail 41, 42 via an electrical cable.

As shown in the example in FIG. 2, the support system 1 comprises two side structures 50 and the support structure 3 is interposed between said side structures 50. Preferably, the side structures 50 abut the support structure 3 laterally. In this case, the side electrified rail 51 is placed in the side structure 50 to the left of the central structure 3.

Preferably, the side structure 50 comprises a groove 52 into which the side electrified rail 51 is inserted. Preferably, such a groove 52 has a complementary shape to that of the side electrified rail 51. Preferably, the side electrified rail 51 is inserted into this groove 52 along the height direction J.

Preferably, the side electrified rail 51 comprises a plastic element 53, e.g. made of polycarbonate, on which a first 54 and a second conductive tabs 55, e.g. made of copper, are placed.

Preferably, the side structure 50 comprises a lower closing insulating element 108 and an upper closing insulating element 109.

The support system 1 comprises a side connection device 60 shaped to connect the support structure 3 and the side structure 50.

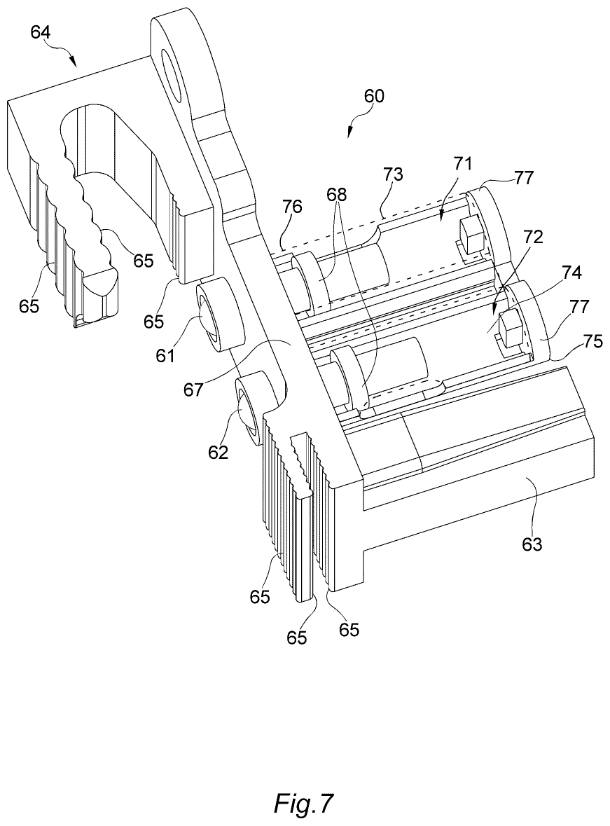

As best seen in the example in FIG. 7, the side connection device 60 comprises a first connection portion 63, configured to connect to the support structure 3, and a second connection portion 64, configured to connect to the side structure 50.

Preferably, the first connection portion 63 comprises a profile with a substantially constant cross-section, which can be inserted into the central housing 30. This section has a dimension along the height direction J substantially equal to that of the central housing 30.

Preferably, this section can be inserted into the central housing 30 through a side opening of the central housing 30.

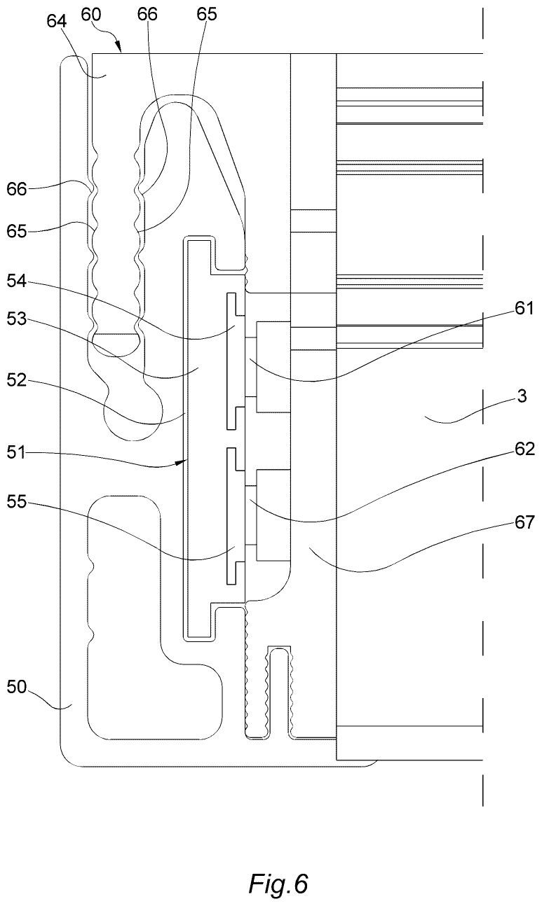

Preferably, the second connection portion 64 comprises a first curved profile that can be inserted into the side structure 50, preferably in a recess of the latter, as best seen in the example of FIG. 6 in which a section along a plane perpendicular to the height direction J of the side structure 50 is shown, at the interface between the pins 61, 62 and the side electrified rail 51.

Thanks to the aforementioned connection portions of the side connection device 60, it is possible to keep the side structure 50 fixed in position, so that the side electrified rail 51 is held in the correct position with respect to the pins 61, 62.

Preferably, the side connection device 60 comprises irregular interface surfaces 65 adapted to interface with the side structure 50. This allows to increase the seal between the side connection device 60 and side structure 50 through friction. Preferably, the side structure 50 comprises irregular interface surfaces 66 that interface with the irregular interface surfaces 65 of the side connection device 60.

In the embodiment shown in FIG. 2, two side connection devices 60 are shown, each of which is placed between the support structure 3 and the respective side structure 50, so as to connect said support structure 3 to each side structure 50. In this embodiment, it is shown that the side connection device 60 containing pins 61, 62 is the one that interfaces with the side structure 50 containing the electrified side rail 51, i.e. the side structure on the left, looking at FIG. 2.

In the event that the first 61 and second pins 62 are positioned in the side connection device 60, the latter is shaped to align these pins 61, 62 with the side electrified rail 51.

The side connection device 60 is configured to align each pin 61, 62 along a direction parallel to the longitudinal direction K of the support structure 3. As best seen in the example in FIG. 6, the side connection device 60 is configured so that the first pin 61 interfaces with the first conductive tab 54 of the side electrified rail 51 and the second pin 62 interfaces with a second conductive tab 55 of the side electrified rail 51.

Preferably, the side connection device 60 comprises a first 71 and a second housings 72 in which the first 61 and the second pins 62 are located, respectively. Each pin 61, 62 can preferably slide in the respective housing 71, 72 along a direction parallel to the longitudinal direction K of the support structure 3. Preferably, each housing 71, 72 is delimited by a first 73 and a second casings 74, respectively. Each casing 73, 74 preferably includes a lower shell 75 and an upper shell 76. In the example in FIG. 7, the upper shells 76 are shown in a dotted line, i.e. in transparency for the sake of visual clarity.

Preferably, the first casing 73 includes a first opening through which the first electrical cable can pass so as to connect the first pin 61 with the first central electrified rail 41 and the second casing 74 includes a second opening through which the second electrical cable can pass so as to connect the second pin 62 with the second central electrified rail 42.

Preferably, the first 73 and the second casings 74 are placed in the central housing 30 of the support structure 3. Preferably, the first 73 and the second casings 74 are insertable into the central housing 30 through the side opening of such central housing 30.

Preferably, the side connection device 60 comprises an abutment wall 67 adapted to abut the support structure 3. Preferably, this abutment wall 67 comprises openings through which pins 61, 62 can interface with the side electrified rail 51.

The side connection device 60 comprises a first and second elastic elements (not shown). The first elastic element exerts a thrust on the first pin 61 and the second elastic element exerts a thrust on the second pin 62, in order to keep these pins 61, 62 in contact with the side electrified rail 51. Preferably, the pins 61, 62 are pushed outwards from their respective casings 73, 74 by the respective elastic elements until the shoulder 68 of each pin 61, 62 abuts the abutment wall 67.

Preferably, each elastic element is configured as a helical spring.

Each elastic element abuts on one side a wall of the side connection device 60 and on the other a shoulder 68 of the pin 61, 62.

Preferably, the first elastic element abuts a bottom wall 77 of the first casing 73, on one side, and the shoulder 68 of the first pin 61, on the other side.

Preferably, the second elastic element abuts a bottom wall 77 of the second casing 74, on one side, and the shoulder 68 of the second pin 62, on the other side.

Below are some variants related to the interconnection between the coupling portion 25 and the support structure.

The references herein are purely indicative, aimed at facilitating the intelligibility of the presentation and correspondence to the elements indicated in the appended figures, even if the specific variant is not illustrated in the drawings accompanying this application.

In a first variant, the contact end 93 is rectilinear and oblique with respect to the intermediate portion 94: during insertion from the central opening 31 and the rotation R generated by the weight P, the inclined edge of the contact end 93 progressively wedges against the central electrified rail 41, 42, in particular on the conductive tab 44, producing self-centring, slight surface cleaning and contact pressure that increases in a controlled manner with the rotation R, without requiring a curvature of the contact end 93 itself.

In another variant, the contact end 93 has a “J” or “S” shaped profile with a gentle double curvature: the first curvature facilitates entry with low resistance, the second creates a support zone with a wider radius that distributes the load on the central electrified rail 41, 42, stabilising the electrical contact on the conductive tab 44 even in the presence of small misalignments and mitigating pressure peaks during shocks and vibrations.

In a further variant, the contact end 93 is shaped like a bifurfcated fork with two distinct teeth: one tooth makes the mechanical coupling against the plastic element 43 of the central electrified rail 41, 42 and the other tooth makes the electrical contact against the conductive tab 44; thus the mechanical and electrical functions are physically separate but coexist in the same contact end 93, reducing micro-movements without the need for additional elastic elements.

In yet another variant, the contact end 93 defines an open slot (semi-loop) that embraces a raised part of the central electrified rail 41, 42: the slot guides the self-alignment on insertion and, at the end of rotation R, creates a positive constraint that counteracts accidental release; the width of the slot also controls transverse sliding, stabilising the contact on the conductive tab 44.

In yet another variant, the cooperation between the coupling portion 25 and the central electrified rail 41, 42 takes place by means of complementary protrusions: one protrusion is formed on the contact end 93 and another protrusion is formed on the central electrified rail 41, 42; during the rotation R the protrusions enter into controlled interference with a cam effect, generating the mechanical grip and working pressure necessary for the electrical contact on the conductive tab 44, even when the contact end 93 is not distal with respect to the insulating element 24.

In a further variant, the contact end 93 incorporates a rolling element (e.g. a small cylinder free to rotate) that slides on the conductive tab 44 during insertion: the rolling reduces wear and improves the wiping action, while the reaction of the central electrified rail 41, 42 at the end of rotation R generates a stable preload on the contact point.

In another variant, the end surface of the contact end 93 is concave and co-operates with a convex raised part of the central electrified rail 41, 42: the concave/convex pair produces transverse self-centring, defines a repeatable working position and ensures a well-localised mechanical grip, while maintaining reliable electrical contact with the conductive tab 44.

In a further variant, the contact end 93 is conformed as an integral elastic flap formed in the same conductive foil as the coupling portion 25: while relying on the rotation R, the flap provides limited elastic recovery that compensates for tolerances and vibrations, maintaining pressure against the central electrified rail 41, 42 and ensuring continuity of contact on the conductive tab 44 without separate springs.

In another variant, the grip does not take place at the tip but on a side contact shoe made on the coupling portion 25: during rotation R, the shoe slides and rests laterally on the conductive tab 44, increasing the useful contact surface and making the coupling less sensitive to vertical stresses, while remaining compatible with the central housing 30 and the grooves 34, 35.

In a further variant, the contact end 93 is shaped like a wedge with an anti-return step: on insertion, the step passes over a small lip of the central electrified rail 41, 42 and rests on it; the release requires an intentional reverse manoeuvre (contrary rotation and controlled traction), while the surface of the step also performs a wiping action on the conductive tab 44.

Still in another variant, the contact end 93 is proximal to the insulating element 24 (and not necessarily distal): the rotation R nevertheless generates the appropriate lever arm to press the contact end 93 against the central electrified rail 41, 42; the smaller projection can reduce the bulks in the central housing 30 while maintaining adequate pressure on the conductive tab 44.

In a further variant, the contact end 93 defines a split contact at height with two surfaces located at different heights: a lower surface cooperates with the plastic element 43 to stabilise the mechanical coupling and an upper surface provides electrical pressure on the conductive tab 44; the separation of functions reduces micro-movements and maintains constant contact quality.

In another variant, the contact end 93 has a surface with micro-teeth or knurls oriented along the insertion direction: these micro-ridges improve wiping on the conductive tab 44, interrupting any surface films and increasing the stability of the contact in operation.

In a further variant, the contact end 93 comprises a short-stroke compliant zone (integrated telescopic effect) that allows a small elastic or guided retraction during insertion: the compliant zone lowers the engagement force, then, at the end of rotation R, brings the contact end 93 to the working position generating a constant preload against the central electrified rail 41, 42 and a stable contact on the conductive tab 44.

In yet another variant, the contact end 93 is inverted “beak” shaped and cooperates with the lower connection 95 of the coupling portion 25 and the connection 33 of the central housing 30: the trajectory guided by the connections 33, 95 causes the “beak” to first move away from and then return towards the conductive tab 44 during rotation R, achieving self-positioning and working grip on the central electrified rail 41, 42.

In a further variant, the contact end 93 is flat (not curved) and cooperates with an inclined track formed on the central electrified rail 41, 42: sliding on this track, during rotation R, leads to the working position where the contact end 93 presses on the conductive tab 44, replacing the “curved towards the rail” guiding function with a geometric cooperation between flat surface and inclined track.

In another variant, the contact end 93 is cylindrical and slides in a guide channel formed in the central electrified rail 41, 42: the channel constrains the transverse degrees of freedom during insertion and brings the contact end 93 to an end stop near the conductive tab 44, ensuring repeatable positioning and reliable contact.

In a further variant, a barycentric bracing is adopted in which the intermediate portion 94 is elongated while the contact end 93 remains short and compact: the useful moment generated by the weight P in rotation R is retained, but the bulk near the central electrified rail 41, 42 is reduced, improving the interface in the central housing 30 without penalising the contact pressure on the conductive tab 44.

At least one of the preceding variants, where compatible, may also provide that at least one coupling portion 25 comprises the contact end 93 suitable for interfacing with the respective central electrified rail 41, 42, leaving the other coupling portion 25 with a different geometry;

further, the interface may be obtained by means of a protrusion formed on the coupling portion 25 and/or a protrusion formed on the central electrified rail 41, 42, provided that the insertion from the central opening 31, the cooperation with the grooves 34, 35 and the rotation R induced by the weight P ensure the mechanical grip and the electrical contact on the conductive tab 44 under operating conditions.

The alternative conformations described in the previous variants represent specific embodiments of the more general conformations defined in claim 1. In particular:
the articulated conformation may comprise at least an intermediate portion 94 and a contact element is implemented in variants with the contact end 93 in different geometries (L-shaped, J-shaped, S-shaped, bifurcated, with a slot), where the intermediate portion 94 acts as a lever arm between the insulating element 24 and the point of contact with the central electrified rail 41, 42;
the conformation with mobile contact element with respect to a base portion can be implemented in the variant with a rolling element or in the variant with an integral elastic flap, where the contact element has controlled degrees of freedom with respect to the base portion 28;
the conformation with a receiving cavity or protrusion for electrical coupling can be implemented in variants with a concave/convex surface, with an open slot embracing a raised part, or with complementary protrusions entering into controlled interference;
the conformation with an elastically deformable section can be implemented in the variant with integral elastic flap or in the variant with a short-stroke compliant zone, where the elastic deformability is integrated into the coupling portion 25 itself;
the conformation with inclined or wedge profile can be implemented in variants with an oblique straight end, with a wedge profile with anti-return step, or with an inclined track on the rail, where the controlled geometric interference generates the necessary contact force. In all these conformations, the weight P of the shelf 2, through a tendency towards rotation R about the fulcrum portion 27, can generate and it maintains by gravity the contact force required for the electrical coupling, without requiring elastic elements interposed between the coupling portion 25 and the central electrified rail 41, 42.

It is understood that this contact force can be achieved by means of a cam or other type of device, which is known and not depicted in the figures, and which can be implemented by the installer or user.

The articulated conformation in detail may comprise:
the intermediate portion 94 configured as a rigid arm extending from the base portion 28 with a length of e.g. 15 to 25 mm, and which can be made of zamak or aluminium like the rest of the conductive element 23.
an intermediate joint positioned at the distal end of the intermediate portion 94 and which may comprise a miniaturised cylindrical hinge that could have a diameter of approximately 2-3 mm and which defines an axis of rotation perpendicular to the longitudinal direction K of the support structure and an angular range limited to, for example, approximately 15-20°;
an articulated contact element connected to the intermediate portion via the intermediate joint and comprising a contact arm, e.g. 5-8 mm in length, with a shaped contact surface, e.g. with a radius of curvature of approximately 10 mm, and increased thickness (e.g. of 2-3 mm) in the interface zone with the conductive tab 44.

The operation of this articulated configuration would, therefore, envisage that when inserting the coupling portion 25 into the central housing 30, there would be in sequence:
the articulated contact element in a neutral position, aligned with the intermediate portion;
when it meets the central electrified rail 41, 42, the contact element rotates about the intermediate joint, adapting to the profile of the rail;
in coupling, the weight P of the shelf (or a coupling force exerted by a dedicated mechanism) generates the rotation R about the fulcrum portion 27, causing a bending moment on the intermediate portion 94 which acts as a primary lever, a secondary rotation of the articulated contact element about the joint resulting in optimal distribution of the contact force over a greater surface, achieving various advantages including:
a double leverage effect in which the intermediate portion 94 multiplies the force resulting from the weight of the shelf (or coupling force), while the articulation allows for optimal self-alignment;
tolerance compensation: the joint absorbs misalignments, e.g. up to ±2 mm between shelf and support structure;
uniform load distribution: the articulated contact element adapts to the surface of the conductive tab 44 distributing the pressure (e.g. over approximately 15-20 mm² with reference to the dimensions hypothesized above by way of non-limiting example only);
reduction of localised wear: the articulated movement during insertion/removal prevents direct dragging, limiting abrasion of materials in mutual contact.

1. Shelf support system comprising:
a shelf comprising:
a main body,
a lighting device,
a first and second connection elements, each connection element comprising a conductive element including a coupling portion and a power supply portion, and an insulating element including a fulcrum portion, said connection elements being connected to the main body so that the fulcrum portion is interposed between the coupling portion and the main body, each power supply portion being electrically connected to the power supply device; and
a support structure comprising a central housing in which a first and a second central electrified rails are housed, said central housing comprising a central opening through which the connection elements of the shelf are inserted into the central housing, so that the coupling portion of the first connection element abuts the first central electrified rail and the coupling portion of the second connection element abuts the second central electrified rail and that the fulcrum portions of the first and second connection elements both abut a first wall delimiting such central housing, the weight of the shelf generating a rotation about the fulcrum portion keeping the coupling portion of the first and second connection elements in contact with the first and second central electrified rails, respectively, each power supply portion being electrifiable through said abutment between the coupling portions and the central electrified rails, to power the lighting device;
wherein at least one coupling portion (25), and/or the respective central electrified rail (41, 42) to which the at least one coupling portion (25) is configured to electrically interface with an electrically conductive contact zone, has a conformation selected from:
an articulated conformation comprising at least an intermediate portion (94) and a contact element adapted to establish an electrical contact with a central electrified rail (41, 42);
a conformation comprising a movable contact element with respect to a base portion (28) of the coupling portion (25) or of the central electrified rail (41, 42);
a conformation comprising at least one of a receiving cavity and a protrusion, configured for electrical coupling with a complementary conformation present on the central electrified rail (41, 42) or, respectively, on the coupling portion (25) and/or on an associated element;
a conformation comprising at least one elastically deformable section;
an inclined profile or wedge conformation configured to generate a shape coupling adapted to determine a contact force by controlled geometric interference to establish an electrical coupling between the coupling portion (25) and the central electrified rails (41, 42); said conformation being configured so that, following coupling of the shelf (2) with the support structure (3), a contact force between the contact zone of the coupling portion (25) and the respective central electrified rail (41, 42) is exerted even in the absence of elastic elements interposed between the coupling portion and the central electrified rail; wherein preferably said contact force is generated by the weight (P) of the shelf (2) which, tending to implement by gravity a rotation (R) about the fulcrum portion (27), generates and maintains said contact force.

2. Shelf support system according to claim 1, wherein the insulating element is configured as a casing comprising a cavity in which the conductive element is inserted, so that the coupling portion and the power supply portion protrude from such cavity of the insulating element, wherein optionally each coupling portion comprises a contact end that interfaces with the respective central electrified rail, such contact end being distal with respect to the insulating element and being curved towards the respective central electrified rail.

3. Shelf support system according to claim 1, wherein each coupling portion comprises a contact end that interfaces with the respective central electrified rail, such contact end being distal with respect to the insulating element and being curved towards the respective central electrified rail.

4. Shelf support system according to claim 1, wherein the central housing comprises a first groove in which the first central electrified rail is inserted and a second groove in which the second central electrified rail is inserted, wherein optionally said grooves are obtained at a second wall of the central housing, such second wall being located higher than the first wall, and wherein optionally said first groove is further away from the central opening than said second groove, and wherein the coupling portion of the first connection element has a greater length with respect to a length of the coupling portion of the second connection element.

5. Shelf support system according to claim 2, wherein the central housing comprises a first groove in which the first central electrified rail is inserted and a second groove in which the second central electrified rail is inserted, wherein optionally said grooves are obtained at a second wall of the central housing, such second wall being located higher than the first wall, and wherein optionally said first groove is further away from the central opening than said second groove, and wherein the coupling portion of the first connection element has a greater length with respect to a length of the coupling portion of the second connection element.

6. Shelf support system according to claim 3, wherein the central housing comprises a first groove in which the first central electrified rail is inserted and a second groove in which the second central electrified rail is inserted, wherein optionally said grooves are obtained at a second wall of the central housing, such second wall being located higher than the first wall, and wherein optionally said first groove is further away from the central opening than said second groove, and wherein the coupling portion of the first connection element has a greater length with respect to a length of the coupling portion of the second connection element.

7. Shelf support system according to claim 1, wherein the power supply portion protrudes laterally with respect to the insulating element, so that both insulating elements are interposed between said power supply portions.

8. Shelf support system according to claim 2, wherein the power supply portion protrudes laterally with respect to the insulating element, so that both insulating elements are interposed between said power supply portions.

9. Shelf support system according to claim 3, wherein the power supply portion protrudes laterally with respect to the insulating element, so that both insulating elements are interposed between said power supply portions.

10. Shelf support system according to claim 4, wherein the power supply portion protrudes laterally with respect to the insulating element, so that both insulating elements are interposed between said power supply portions.

11. Shelf support system according to claim 1, wherein the main body of the shelf includes a first housing, in which the power supply portion and the insulating element, with the exception of the fulcrum portion, of each connection element are housed, and a second housing in which the lighting device is housed, the first housing comprising a first and second side openings, these side openings being mutually opposed, wherein the power supply portion of the first connection element is at the first side opening and the power supply portion of the second connection element is at the second side opening, wherein a first electrical cable passes through the first opening into the second housing, connecting the power supply portion of the first connection element with the lighting device, and wherein a second electrical cable passes through the second opening into the second housing, connecting the power supply portion of the second connection element with the lighting device, wherein optionally the shelf comprises a first side cover element, connected to the main body of the shelf to cover the first side opening, and a second side cover element, connected to the main body of the shelf to cover the second side opening, and wherein optionally the first housing is delimited by a transverse wall, and wherein each insulating element comprises a fastening element that can be fastened to said transverse wall.

12. Shelf support system according to claim 2, wherein the main body of the shelf includes a first housing, in which the power supply portion and the insulating element, with the exception of the fulcrum portion, of each connection element are housed, and a second housing in which the lighting device is housed, the first housing comprising a first and second side openings, these side openings being mutually opposed, wherein the power supply portion of the first connection element is at the first side opening and the power supply portion of the second connection element is at the second side opening, wherein a first electrical cable passes through the first opening into the second housing, connecting the power supply portion of the first connection element with the lighting device, and wherein a second electrical cable passes through the second opening into the second housing, connecting the power supply portion of the second connection element with the lighting device, wherein optionally the shelf comprises a first side cover element, connected to the main body of the shelf to cover the first side opening, and a second side cover element, connected to the main body of the shelf to cover the second side opening, and wherein optionally the first housing is delimited by a transverse wall, and wherein each insulating element comprises a fastening element that can be fastened to said transverse wall.

13. Shelf support system according to claim 3, wherein the main body of the shelf includes a first housing, in which the power supply portion and the insulating element, with the exception of the fulcrum portion, of each connection element are housed, and a second housing in which the lighting device is housed, the first housing comprising a first and second side openings, these side openings being mutually opposed, wherein the power supply portion of the first connection element is at the first side opening and the power supply portion of the second connection element is at the second side opening, wherein a first electrical cable passes through the first opening into the second housing, connecting the power supply portion of the first connection element with the lighting device, and wherein a second electrical cable passes through the second opening into the second housing, connecting the power supply portion of the second connection element with the lighting device, wherein optionally the shelf comprises a first side cover element, connected to the main body of the shelf to cover the first side opening, and a second side cover element, connected to the main body of the shelf to cover the second side opening, and wherein optionally the first housing is delimited by a transverse wall, and wherein each insulating element comprises a fastening element that can be fastened to said transverse wall.

14. Shelf support system according to claim 4, wherein the main body of the shelf includes a first housing, in which the power supply portion and the insulating element, with the exception of the fulcrum portion, of each connection element are housed, and a second housing in which the lighting device is housed, the first housing comprising a first and second side openings, these side openings being mutually opposed, wherein the power supply portion of the first connection element is at the first side opening and the power supply portion of the second connection element is at the second side opening, wherein a first electrical cable passes through the first opening into the second housing, connecting the power supply portion of the first connection element with the lighting device, and wherein a second electrical cable passes through the second opening into the second housing, connecting the power supply portion of the second connection element with the lighting device, wherein optionally the shelf comprises a first side cover element, connected to the main body of the shelf to cover the first side opening, and a second side cover element, connected to the main body of the shelf to cover the second side opening, and wherein optionally the first housing is delimited by a transverse wall, and wherein each insulating element comprises a fastening element that can be fastened to said transverse wall.

15. Shelf support system according to claim 7, wherein the main body of the shelf includes a first housing, in which the power supply portion and the insulating element, with the exception of the fulcrum portion, of each connection element are housed, and a second housing in which the lighting device is housed, the first housing comprising a first and second side openings, these side openings being mutually opposed, wherein the power supply portion of the first connection element is at the first side opening and the power supply portion of the second connection element is at the second side opening, wherein a first electrical cable passes through the first opening to reach the second housing, connecting the power supply portion of the first connection element with the lighting device, and wherein a second electrical cable passes through the second opening into the second housing, connecting the power supply portion of the second connection element with the lighting device, wherein optionally the shelf comprises a first side cover element, connected to the main body of the shelf to cover the first side opening, and a second side cover element, connected to the main body of the shelf to cover the second side opening, and wherein optionally the first housing is delimited by a transverse wall, and wherein each insulating element comprises a fastening element that can be fastened to said transverse wall.

16. Shelf support system according to claim 1, comprising:
a side structure in which a side electrified rail is inserted,
a first pin electrically connected to the first central electrified rail,
a second pin electrically connected to the second central electrified rail, this side structure being positioned with respect to the support structure so that the first and second pins abut the side electrified rail, which optionally comprises a side connection device in which the first and second pins are positioned, and shaped so as to connect the support structure to the side structure and to align these pins to the side electrified rail, and wherein optionally the side connection device comprises a first and second elastic elements, the first elastic element exerting a thrust on the first pin and the second elastic element exerting a thrust on the second pin, to keep these pins in contact with the side electrified rail.

17. Shelf support system according to claim 2, comprising:
a side structure in which a side electrified rail is inserted,
a first pin electrically connected to the first central electrified rail,
a second pin electrically connected to the second central electrified rail, this side structure being positioned with respect to the support structure so that the first and second pins abut the side electrified rail, which optionally comprises a side connection device in which the first and second pins are positioned, and shaped so as to connect the support structure to the side structure and to align these pins to the side electrified rail, and wherein optionally the side connection device comprises a first and second elastic elements, the first elastic element exerting a thrust on the first pin and the second elastic element exerting a thrust on the second pin, to keep these pins in contact with the side electrified rail.

18. Shelf support system according to claim 3, comprising:
a side structure in which a side electrified rail is inserted,
a first pin electrically connected to the first central electrified rail,
a second pin electrically connected to the second central electrified rail, this side structure being positioned with respect to the support structure so that the first and second pins abut the side electrified rail, which optionally comprises a side connection device in which the first and second pins are positioned, and shaped so as to connect the support structure to the side structure and to align these pins to the side electrified rail, and wherein optionally the side connection device comprises a first and second elastic elements, the first elastic element exerting a thrust on the first pin and the second elastic element exerting a thrust on the second pin, to keep these pins in contact with the side electrified rail.

19. Shelf support system according to claim 4, comprising:
a side structure in which a side electrified rail is inserted,
a first pin electrically connected to the first central electrified rail,
a second pin electrically connected to the second central electrified rail, this side structure being positioned with respect to the support structure so that the first and second pins abut the side electrified rail, which optionally comprises a side connection device in which the first and second pins are positioned, and shaped so as to connect the support structure to the side structure and to align these pins to the side electrified rail, and wherein optionally the side connection device comprises a first and second elastic elements, the first elastic element exerting a thrust on the first pin and the second elastic element exerting a thrust on the second pin, to keep these pins in contact with the side electrified rail.

20. Shelf support system according to claim 7, comprising:
a side structure in which a side electrified rail is inserted,
a first pin electrically connected to the first central electrified rail,
a second pin electrically connected to the second central electrified rail, this side structure being positioned with respect to the support structure so that the first and second pins abut the side electrified rail, which optionally comprises a side connection device in which the first and second pins are positioned, and shaped so as to connect the support structure to the side structure and to align these pins to the side electrified rail, and wherein optionally the side connection device comprises a first and second elastic elements, the first elastic element exerting a thrust on the first pin and the second elastic element exerting a thrust on the second pin, to keep these pins in contact with the side electrified rail.

21. Shelf support system according to claim 11, comprising: a side structure in which a side electrified rail is inserted,
a first pin electrically connected to the first central electrified rail,
a second pin electrically connected to the second central electrified rail, this side structure being positioned with respect to the support structure so that the first and second pins abut the side electrified rail, which optionally comprises a side connection device in which the first and second pins are positioned, and shaped so as to connect the support structure to the side structure and to align these pins to the side electrified rail, and wherein optionally the side connection device comprises a first and second elastic elements, the first elastic element exerting a thrust on the first pin and the second elastic element exerting a thrust on the second pin, to keep these pins in contact with the side electrified rail.

22. Wall panelling comprising a shelf support system according to claim 1, a lower structure, an upper structure, a lower cladding panel and an upper cladding panel, said lower cladding panel being held in place by means of the lower structure and the support structure and said upper cladding panel being held in place by means of the upper structure and the support structure.
